(19) United States
(12) Patent Application Publication
(10) Pub. No.: US 2006/0268010 A1
(43) Pub. Date: Nov. 30, 2006

(54) Processing an overlay based on configured and settings values

(76) Inventors: Manjunath Hadli, Fraser Town (IN); Anil Arun Degwekar, Indiranagar (IN); Radha Krishna Srimanthula, Warangal (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/142,197

(22) Filed: May 31, 2005

(51) Int. Cl. G09G 5/00

(52) U.S. Cl. 345/629

(57) ABSTRACT

Apparatus and method are disclosed to configure the overlay hardware based on the effective values. The effective values are generated based on both the configured values provided by a user and the settings values provided by the graphics application and the effective values may be applied to the overlay.

### BACKGROUND

A computer system generally comprises processing devices, memory devices, interface devices, and input-output (I/O) devices. An interface device often couples one or more of processing devices, memory devices, and I/O devices. For example, an interface device may process and transfer display data corresponding to surfaces such as primary display surfaces and overlays that may be rendered on a display device such as a computer monitor.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale.

For example, the dimensions of some elements may be exaggerated relative to other elements for clarity. Further, where considered appropriate, reference labels have been repeated among the figures to indicate corresponding or analogous elements.

FIG. 1 illustrates an embodiment of a computer system.

FIG. 2 illustrates an embodiment of a graphics controller of FIG. 1.

FIG. 3 illustrates an operation of an embodiment of the graphics controller of FIG. 2.

FIGS. 4A and 4B illustrate an embodiment of a graphics user interface (GUI) that a user may use to provide inputs.

FIG. 5 illustrates an operation of an embodiment of the graphics controller of FIG. 2.

FIG. 6 illustrates an operation of an embodiment of the graphics controller of FIG. 2.

### DETAILED DESCRIPTION

The following description describes a system for processing an overlay. In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

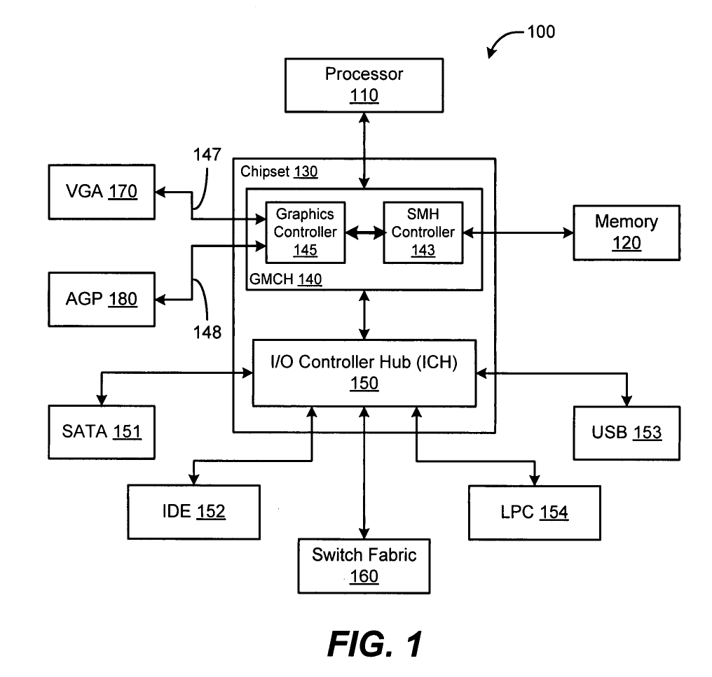

An embodiment of a computer system 100 is illustrated in FIG. 1. The computer system 100 may comprise a processor 110, a memory 120, a chipset 130, one or more I/O interfaces such as Serial Advanced Technology Attachment (SATA) 151, Integrated Drive Electronics (IDE) 152, Universal Serial Bus (USB) 153, a Low Pin Count (LPC) 154, switch fabric 160, video graphics array (VGA) interface 170, and an accelerated graphics port (AGP) interface 180.

The processor 110 may manage various resources and processes within the computer system 100 and may execute software instructions as well. The processor 110 may comprise, for example, one or more microprocessors from the Pentium®, Itanium®, or XScale™ family of Intel® microprocessors. The processor 110 may interface with the chipset 130 to retrieve from the memory 120 and to store data into the memory 120. The processor 110 may be coupled to I/O devices through interfaces such as the SATA 151, the IDE 152, the USB 153, the LPC 154, the switch fabric 160, the VGA interface 170 and the AGP interface 180.

The memory 120 may store data and instructions and may comprise one or more different types of memory devices such as DRAM (Dynamic Random Access Memory) devices, SDRAM (Synchronous DRAM) devices, DDR (Double Data Rate), or other volatile and non-volatile memory devices used in computers.

The SATA 151, IDE 152, USB 153, LPC 154, and the switch fabric 160 may comprise one or more ports to transfer packets between the chipset 130 and I/O devices coupled to the interfaces 151-160. For example, the switch fabric 160 may transfer packets between one or more PCI devices coupled to the switch fabric 160 and the chipset 130 on corresponding links such as a PCI express point-to-point links that are coupled to downstream ports of the switch fabric 160. The switch fabric 160 may transmit the packets received from I/O devices to the chipset 130 via an upstream port of the switch fabric 160.

The chipset 130 may comprise one or more integrated circuits or chips that operatively couple the processor 110, the memory 120, and the devices coupled to one or more of the input-output interfaces or ports. The chipset 130 may be one from the family of Intel® chipsets. In one embodiment, the chipset 130 may comprise a graphics and memory controller hub (GMCH) 140 and an I/O controller hub (ICH) 150. The chipset 130 may receive packets corresponding to a transaction generated by the devices coupled to one or more of the input-output interfaces on corresponding links and may forward the packets to the memory 120 and the processor 110.

The ICH 150 may provide an interface between various input-output (I/O) devices coupled to the ICH 150 and the processor 110 and the memory 120. For example, the ICH 150 may support, for example, hard disk drive, floppy drive, CD drives, modems, keyboards, printers, mouse, endpoints, Ethernet and SCSI devices coupled to interfaces such as SATA 151, IDE 152, USB 153, LPC 154, and switch fabric 160.

The GMCH 140 may process the transactions and transfer the corresponding data between the memory 120, the ICH 150, the processor 110, the devices coupled to the VGA interface 170 and the AGP interface 180. An embodiment of the GMCH 140 may comprise a system-memory-ICH (SMH) controller 143 and a graphics controller 145. The SMH controller 143 may receive, process, and transmit packets generated by one of the processor 110, the memory 120, and the ICH 150. For example, the packets received from the ICH 150 may be sent to the memory 120 and the processor 110 respectively for storing and processing.

The graphics controller 145 may process the data packets before sending to corresponding devices coupled to VGA interface 170, the AGP interface 180, and the processor 110. In one embodiment, the graphics controller 145 may be coupled to display devices such as computer monitors via interfaces such as the VGA interface 170, to audio and video devices such as a DVD player, a television, a camera system and such other audio-visual systems via the AGP interface 180 and to the processor 110. In one embodiment, the graphics controller 145 may receive, for example, a video data, process the video data, and may then cause the video data to be displayed on one or more display devices such as a cathode ray tube (CRT) or a liquid crystal display or flat panel display.

The graphics controller 145 may receive data representing, for example, a movie clip and may render the movie clip as an overlaid surface on the primary surface of the display devices such as a desktop monitor, laptop monitor, or some other display device coupled to the VGA interface 170. The monitor surface of the display device may be referred to as a ‘primary display surface’ and the surface laid over on the primary display surface may be referred to as an ‘overlay’. An example of an overlay is a media player application rendered on the computer screen.

The overlay and the primary display surface may have different color properties. In one embodiment, the graphics controller 145 may convert the overlay color properties into primary display surface color properties before rendering the overlay on the primary display surface. The data corresponding to primary display surface and the overlay surface may be stored in different portions of the memory. As a result the overlay surface may be rendered independently on the primary display surface without affecting the primary display surface values.

The overlay color properties may be based on, for example, YUV color space. The YUV color space values may represent luminance and chrominance.

In one embodiment, the luminance may refer to a measure of light power reflected or emitted from an object within a solid angle of one radian per unit area projected in a given direction. The luminance may be based on values such as the brightness and contrast. The chrominance is simply the color portion of the video signal. The chrominance may refer to hue and saturation values, which may be used to measure the difference between two colors of equal brightness.

The primary display surface color properties may be based on color values represented by, for example, a RGB color space. The RGB color space may comprise color values corresponding to red R, green G, and blue B colors. In one embodiment, the graphics controller 145 may provide support for customization of the overlay based on the values provided by a user using a user interface such as a graphics user interface (GUI).

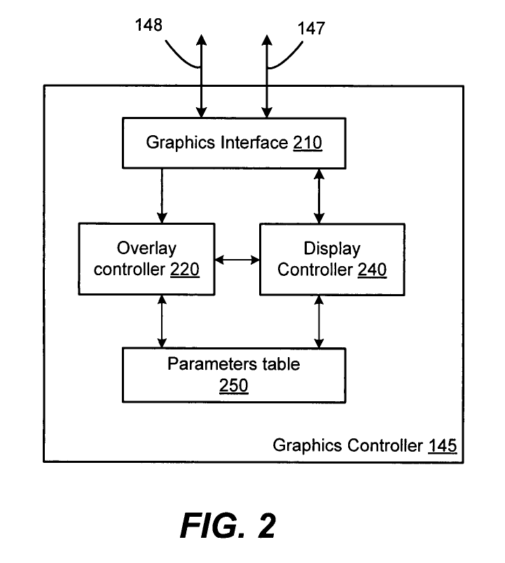

An embodiment of the graphics controller 145 is illustrated in FIG. 2. The graphics controller 145 may comprise a graphics interface 210, an overlay controller 220, a display controller 240, and a parameters table 250.

The graphics interface 210 may receive packets from devices coupled to VGA interface 170 and AGP interface 180 and may forward the packets to one or more of the overlay controller 220 and the display controller 240. The packets received from the display controller 240 may be sent to one of the appropriate devices coupled to the VGA interface 170 and AGP interface 180. The interface 210 may receive, for example, values (‘configured values’) provided by the user using graphic user interface (GUI) and may then send the configured values to one of the overlay controller 220 or the display controller 240. To this end, the graphics interface 210 may implement application program interfaces (API) to enable a user to provide various configured values.

The parameters table 250 may comprise a register, a latch, and some other such storage device. In one embodiment, the parameters table 250 may store various values such as the original values, the change values, the control values corresponding to the primary display surface and the overlay. The stored values may be retrieved by the corresponding controller blocks.

The overlay controller 220 may process the overlay, for example, by converting one or more primary display surface color parameters to a corresponding overlay color values. The overlay controller 220 may receive change values that correspond to a change in the overlay color values, generate the overlay color values based on the change values, and interface with the display controller 240 to enable several features of an embodiment.

In one embodiment, the overlay controller 220 may receive the original primary display surface parameters from the display controller 240 and generate one or more overlay color values. The original primary display surface values may correspond to red R, green G, and blue B values of the color map rendered on the primary display surface. The overlay controller 220 may convert the R, G, and B values into Y, U, and V values to generate the original overlay color values based on the Y, U, and V values corresponding to the original primary display surface parameters. The overlay controller 220 may receive one or more change values provided by the user, which indicate the changes in the overlay, generate one or more new overlay color values based on the change values and send the new overlay color values to the display controller 240 for further processing.

In one embodiment, the overlay controller 220 may generate an initial overlay color values by processing the overlay data using the overlay characteristics such as overlay gamma and send the initial overlay color values to the display controller 240 for further processing.

The display controller 240 may create a graphic frame such as a color map on the primary display surface, determine the original primary display surface parameters, and send the original primary display parameters to the overlay controller 220. The display controller 240 may receive the new overlay color values and convert the new overlay color values into new primary display surface parameters, and recreate the color map based on the new primary display surface parameters.

In one embodiment, the display controller 240 may create a color map, send the corresponding original primary display surface parameters such as the R, G, and B values to the overlay controller 220. The display controller 240 may receive the new overlay color values such as Y, U, and V color values, generate the new primary display surface parameters such as new R, G, and B values based on the new overlay color values, and recreate the color map based on the new R,G, and B values.

The display controller 240 may store the new display surface parameters and may render subsequent overlays based on the new display surface parameters. Such an approach may enable the user to experience the effect of the change values on the overlay.

In one embodiment, the display controller 240 may control the device overlay color values based on the display device characteristics such as a device gamma value. The display controller 240 may receive the initial overlay color values from the overlay controller 220 and further process the initial overlay color values based on the corresponding display device characteristics to generate one or more device overlay color values, and render the overlay in the display devices based on the corresponding device overlay color values. In one embodiment, the gamma value corresponding to a device may represent a numerical value that indicates the linearity of intensity of reproduction in that display device and the device gamma values (device 1 gamma value, device 2 gamma value . . . device n gamma value) may be different for different display devices 1 to n.

For example, the display controller 240 may receive the initial overlay color values form the overlay controller 220; generate a CRT color values based on the CRT gamma value and flat panel color values based on the flat panel gamma value. The display controller 240 may then cause the overlay to be displayed on a cathode ray tube based on the CRT color values and the liquid crystal display based on the flat panel color values.

In one embodiment, processing the overlay color values in the overlay controller 220 based on the overlay control values and then in the display controller 240 based on the device control values of the corresponding display devices may provide better user experience.

In one embodiment, the display controller 240 may generate effective values by processing one or more configured values and one or more graphics hardware correlated values generated from the settings values. The user may provide the configured values using user interface such as graphics user interface and the graphics application such as those using Microsoft® DirectX API (application programming interfaces) may provide settings values to configure the hardware overlay. The settings values may override the configured values provided by the user. In one embodiment, the display controller 240 may receive the configured values and the settings values respectively from the user and the graphics application generate the effective values. The display controller 240 may then configure the hardware overlay based on the effective values.

In one embodiment, the configured values and the settings values may indicate values corresponding to brightness, contrast, saturation, and gamma respectively from the user and the graphics application. The display controller 240 may generate graphics hardware correlated values from the settings values and may use the graphics hardware correlated values and the configured values to generate the effective values, for example, corresponding to the brightness, the contrast, the saturation, and the gamma, which may be used to configure the hardware overlay. Such an approach may preserve the effect of the configured values provided by the user and render a new overlay based on the effective values generated based on both the configured values and the settings values.

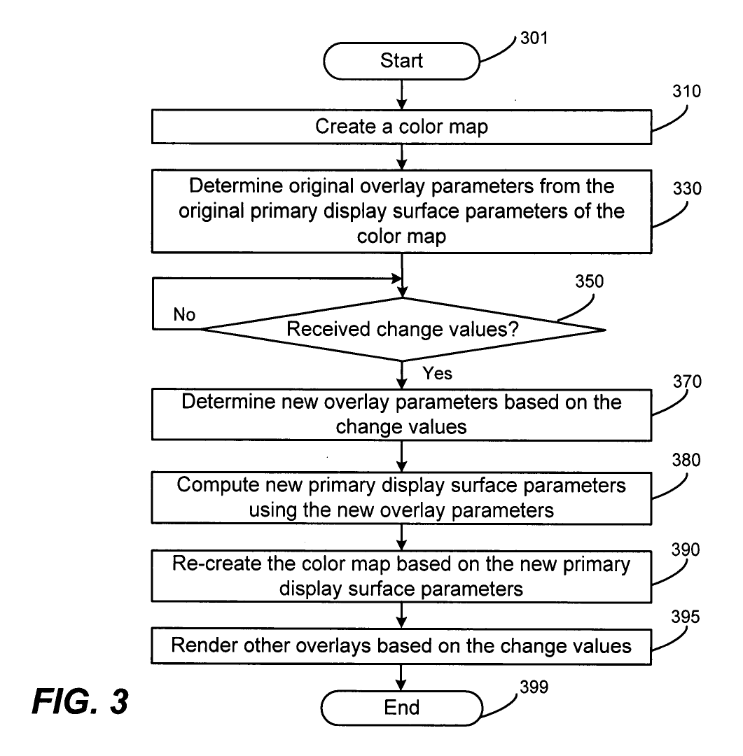

An embodiment of operation of graphics controller 145 is illustrated in FIG. 3. In one embodiment, the graphics controller 145 may enhance the user experience by enabling the user to view the effect of change in overlay color values by displaying a color map reflecting the effect of changes.

In block 310, the display controller 240 may create an original color map, for example, on a GUI screen. For example, the color map may be characterized by R, G, and B values of the RGB color space. In one embodiment, the red, green, and blue color levels may equal one of 0-255 levels. The values of red, green, and blue representing the original primary display parameters may be denoted respectively by Ro, Go, and Bo.

In block 330, the overlay controller 220 may determine the original overlay color parameters based on the original primary display surface parameters of the original color map. In one embodiment, the original overlay parameters may be determined by converting the primary display surface parameters received from the display controller 240 using color space conversion equations. For example, the R, G, and B values of each pixel may be converted into Y, U, and V values by using the color space conversion equations. The original Y, U, and V values represented by Yo, Uo, and Vo corresponding to Ro, Go, and Bo of the original color map created in block 310 may be computed using Equations (1), (2), and (3) respectively and are shown below.
Yo=Ro*0.299+Go*0.587+Bo*0.114 Equation (1)
Uo=Ro*−0.169+Go*−0.332+Bo*0.500+128 Equation (2)
Vo=Ro*0.500+Go*−0.419+Bo*−0.813+128 Equation (3)
wherein +, −, and * respectively represent addition, subtraction, and multiplication operators.

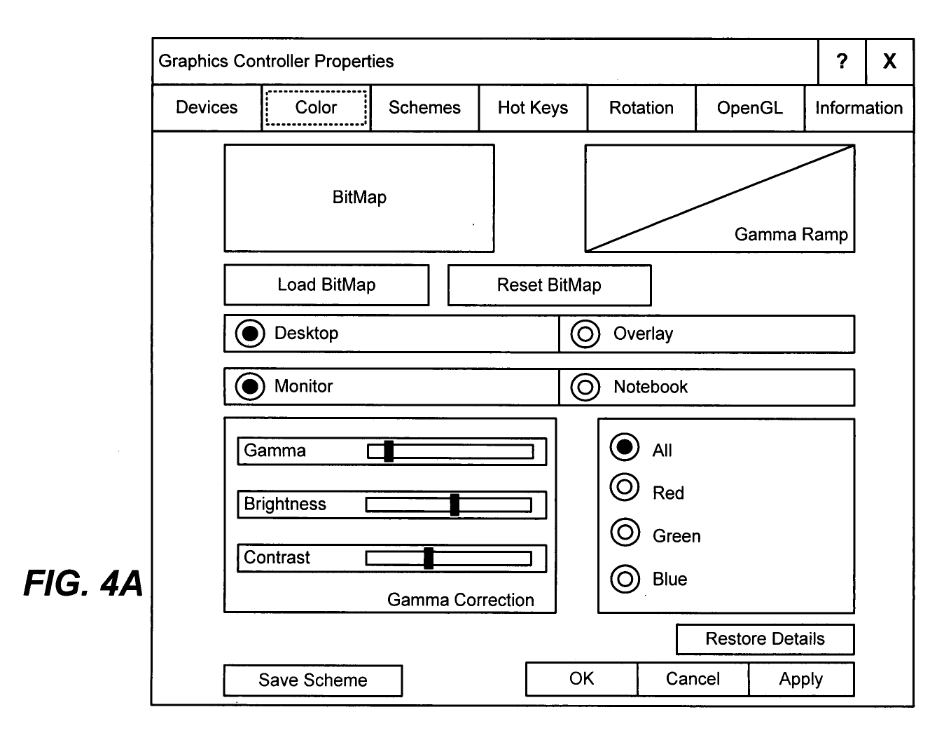

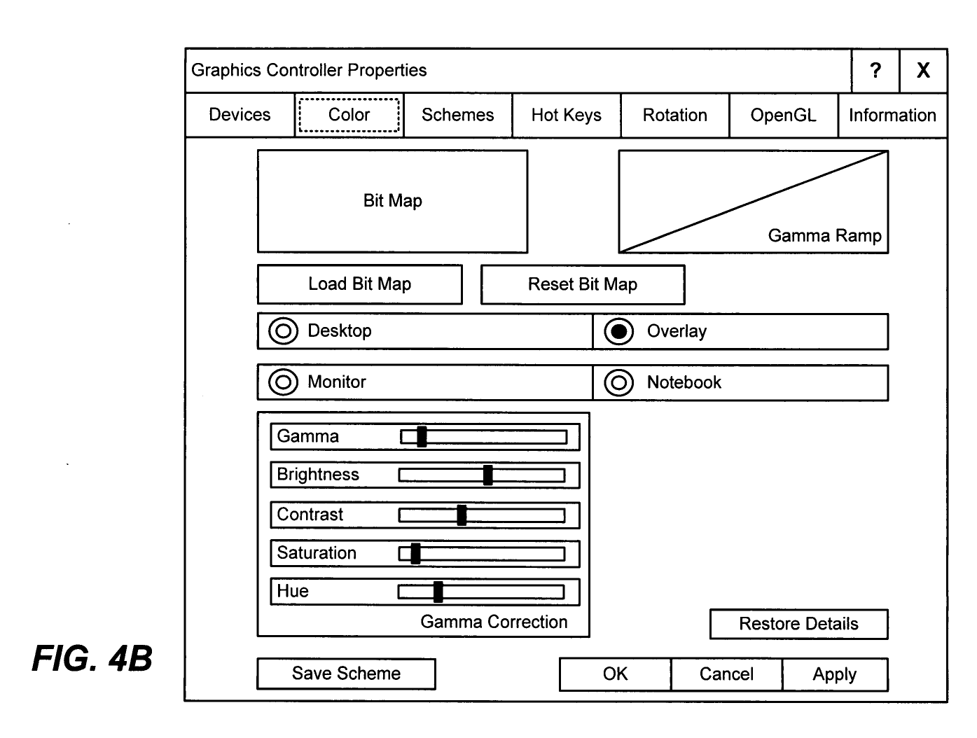

In block 350, the overlay controller 220 may check whether the change values provided by the user are received. For example, the user may provide the change values using a GUI of FIG. 4A and FIG. 4B. After receiving the change values, the overlay controller 220 may continue with block 370 and otherwise, may loop back and wait for the change values. In one embodiment, the user may provide the change values corresponding to an overlay and the change values may represent, for example, gamma, brightness, contrast, saturation, and the hue.

In block 370, the overlay controller 220 may determine new overlay parameters based on the change values. For example, the overlay controller 220 may use the change values corresponding to the contrast and the brightness and the corresponding original overlay parameter Yo to determine a new value Yn, which may represent the luminance. The overlay controller 220 may use the change values corresponding to the saturation value ‘s’, the angular value of hue ‘x’, and the corresponding original overlay parameters Uo and Vo to determine the new values Un and Vn representing the chrominance. In one embodiment, the saturation value ‘s’ may change the dynamic range of chrominance and the hue adjustment ‘x’ may rotate the chrominance axes counter clockwise by an angle ‘x’. The new overlay parameters may be denoted by Yn, Un, and Vn and may be computed using Equations (4), (5), and (6) below.
Yn=Contrast value*(Yo+Brightness value) Equation (4)
Un=s*cos(x)*Uo+s*sin(x)*Vo Equation (5)
Vn=−s*sin(x)*Uo+s*cos(x)*Vo Equation (6)

In block 380, the display controller 240 may generate the new primary display parameters based on the new overlay parameters received from the overlay controller 220. In one embodiment, the display controller 240 may receive the new overlay parameters Yn, Un, and Vn from the overlay controller 220 and compute the new primary display surface parameters Rn, Gn, and Bn. The new primary display surface parameters of Rn, Gn, and Bn may be determined using equations (7), (8), and (9) below.
Rn=Yn+(1.4075*(Vn−128)) Equation (7)
Gn=Yn−(0.3455*(Un−128)−(0.7169*(Vn−128)) Equation (8)
Bn=Yn+(1.7790*(Un−128) Equation (9)

In block 390, the display controller 240 may create a new color map based on the new primary display surface parameters Rn, Gn, and Bn.

In block 395, the display controller 240 may render the other overlay based on the change values. In one embodiment, the user may bring up a subsequent overlay such as a movie clip and the display controller 240 may apply the new overlay color parameters to the overlay. As a result, the user may experience the effect of the change values on the overlay.

Thus, the user may be enabled to provide change values, view the effect of change values on an overlay, store the appropriate change values, and apply the change values to subsequent overlays.

An embodiment of a graphic user interface GUI 400 is illustrated in FIG. 4A and FIG. 4B. In one embodiment, the user may select appropriate options to create the GUI 400 corresponding to the graphics controller properties on the computer monitor.

In one embodiment, the GUI 400 may comprise a toolbar comprising buttons corresponding to Devices, Color, Schemes, Hot Keys, Rotation, OpenGL, and Information. The user may select the Color button, which may cause a window with several options to be displayed as shown in FIG. 4A. The user may provide inputs corresponding to desktop color properties by selecting Desktop and Monitor radio buttons. The user may provide values corresponding to each of gamma, brightness, and contrast by sliding the respective pointers on the corresponding scales. The effect of sliding the corresponding pointers may be viewed by observing the changes in the color map.

The user may provide the overlay color values by selecting the Overlay radio button of FIG. 4A. As a result of selecting the Overlay radio button, in one embodiment, a window as shown in FIG. 4B may be displayed The user may then provide values corresponding to the gamma, the brightness, the contrast, the saturation, and the hue by changing the position of the sliding pointers respectively on the Gamma, Brightness, Contrast, Saturation, and the Hue scales. The effect of the changes in the corresponding position of the pointers may be viewed on a color map such as the bitmap. The changes in the overlay color properties may be emulated by displaying the changes in the bitmap.

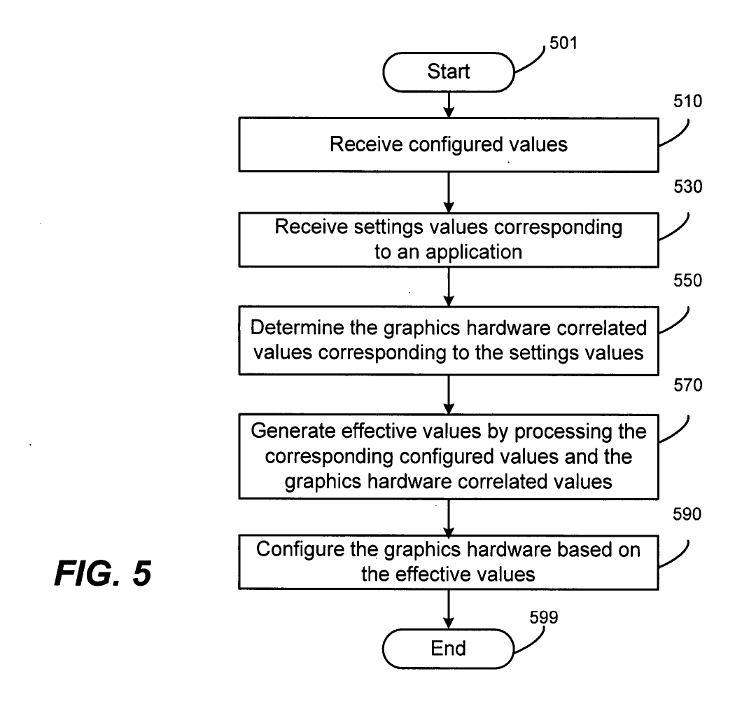

An embodiment of the operation of the graphics controller 145 generating effective values based on the configuration values and the graphics hardware correlated values corresponding to the settings values is illustrated in FIG. 5.

In block 510, the display controller 240 may receive the configuration values provided by the user. As described above in FIG. 4A and FIG. 4B, the user may provide the configuration values using the sliding pointers of the GUI 400. The configuration values may correspond to Gconfig, Bconfig, Cconfig, Sconfig, and Hconfig respectively representing user provided values of the gamma, the brightness, the contrast, the saturation, and the hue.

In block 530, the display controller 240 may receive the settings value corresponding to the graphics application. In one embodiment, the display controller 240 may receive the settings values Gset, Bset, Cset, Sset, and Hset respectively representing values of the gamma, the brightness, the contrast, the saturation, and the hue provided by the graphics application.

In block 550, the display controller 240 may determine the graphics hardware correlated values corresponding to the settings values. In one embodiment, the display controller 240 may compute the graphics hardware correlated values Gcorr, Bcorr, Ccorr, Scorr, and Hcorr by correlating the set values Gset, Bset, Cset, Sset, and the Hset with the corresponding pre-specified range corresponding to the graphics hardware. In one embodiment, the range of values corresponding to Gset, Bset, Cset, Sset, and Hset of the graphics application may respectively equal a value in the range (1 to 500), (0 to 10000), (0 to 20000), (0 to 20,000), and (−180 to +180).

However, the pre-specified range of gamma, brightness, contrast, saturation, and hue of the graphics hardware, in one embodiment, may respectively correspond to (1 to 5), (−128 to +127), (0 to 7.75), (−8 to +8), and (0 to 8). In one embodiment, the display controller 240 may convert the values in the settings range into the corresponding graphics hardware range by correlating the values in the settings range with the corresponding values in the graphics hardware range. For example, the maximum value and the minimum value corresponding to the range of the settings value may be respectively equaled with a maximum value and the minimum value of the range corresponding to the graphics hardware value. The intermediate values of the settings value range may be simply mapped to a corresponding intermediate value of the graphics hardware range.

In block 570, the display controller 240 may generate the effective values, Geff, Beff, Ceff, Seff, and Heff respectively corresponding to the gamma, the brightness, the contrast, the saturation, and the hue by processing the corresponding configured values and the graphics hardware correlated values. In one embodiment, the display controller 240 may respectively compute the effective values Geff, Beff, Ceff, Seff, and Heff using Equations (10), (11), (12), (13), and (14) shown below.
Geff=Gconfig*Gcorr Equation (10)
Beff=Bconfig+Bcorr Equation (11)
Ceff=Cconfig*Ccorr Equation (12)
Seff=Sconfig*Scorr Equation (13)
Heff=Hconfig*Hcorr Equation (14)

It may be observed that the effective value Beff corresponding to the brightness may equal the sum of the corresponding configured brightness value and the graphics hardware correlated brightness value and the effective values corresponding to gamma Geff, contrast Ceff, saturation Seff, and the hue Heff may respectively equal the multiplicative product of the corresponding configured values and the graphics hardware correlated values.

In block 590, the display controller 240 may configure the graphics hardware based on the effective values Geff, Beff, Ceff, Seff, and Heff. In one embodiment, configuring the graphics hardware based on the effective values may preserve the effect of the configured values on the overlay and may render a new overlay based on the configured values as well.

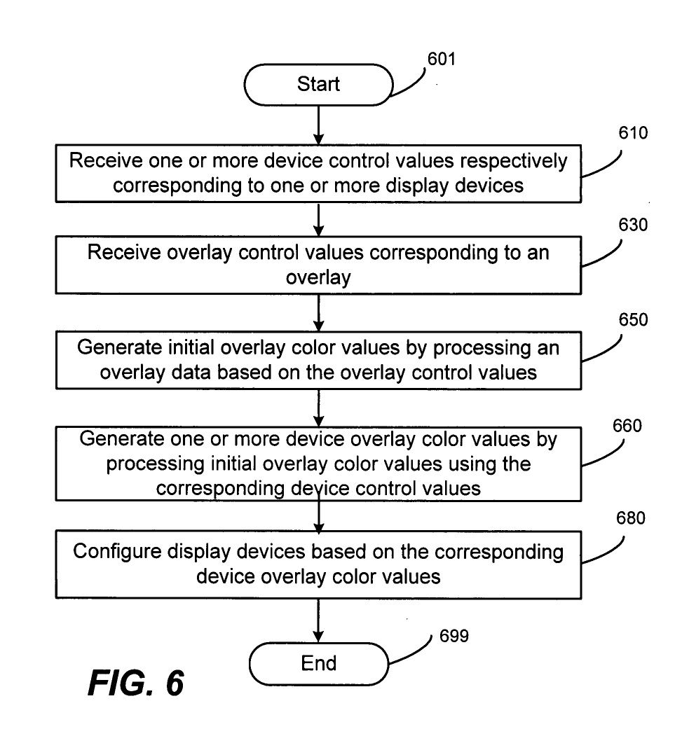

An embodiment of the operation of the graphics controller 145 controlling the overlay color parameters on one or more display surfaces is illustrated in FIG. 6. In one embodiment, the overlay may be displayed on one or more display devices such as a cathode ray tube and a liquid crystal display or flat panel display. For example, the overlay may be displayed on a flat panel and a CRT based on the corresponding display device characteristics such as the flat panel gamma and the CRT gamma. The gamma values may be different for different display devices. In one embodiment, the overlay may be displayed on each display device based on the overlay gamma and the corresponding device gamma.

In block 610, the display controller 240 may receive one or more device control values respectively corresponding to one or more display devices. For example, it may be assumed that the overlay may be displayed on the CRT and the flat panel display. In one embodiment, the display controller 240 may receive the CRT gamma and the flat panel gamma corresponding to the CRT display device and the flat panel display device. The control values may be different for the display devices and may indicate the linearity of the corresponding display device.

In block 630, the overlay controller 220 may receive overlay control values corresponding to an overlay. The overlay control values may, for example, correspond to overlay gamma values. In block 650, the overlay controller 220 may generate initial overlay color values by processing an overlay data based on the overlay control values received in block 620. For example, values corresponding to a movie clip may be processed using the overlay gamma.

In block 660, the display controller 240 may generate the device overlay color values by processing the initial overlay color values based on the respective device control values (device 1 gamma value, device 2 gamma value . . . device n gamma value) corresponding to the display devices 1 to n. In one embodiment, the display controller 240 may generate the CRT overlay color values by processing an initial CRT overlay color values using the CRT gamma value. The display controller 240 may generate flat panel overlay color values by processing an initial flat panel overlay color values using the flat panel gamma value.

To this end, the overlay data may be processed corresponding to the CRT display device based on both the overlay gamma value and the CRT gamma value. Similarly, the overlay data may be processed corresponding to the flat panel display device based on both the overlay gamma value and the flat panel gamma value. In other words, the overlay data may be processed based on the effective CRT gamma equaling (the overlay gamma*the CRT gamma) in the CRT display device and the effective flat panel gamma equaling (the overlay gamma*the flat panel gamma) in the flat panel display device. The ‘*’ operator represents a multiplication operation.

In block 680, the display controller 240 may configure the corresponding display devices based on the respective device overlay color values. In one embodiment, the display controller 240 may configure the display hardware such as a cathode ray tube using the CRT overlay color value and a liquid crystal display using the flat panel color overlay value.

The device overlay color values may be generated based on the overlay gamma and the corresponding device gamma. As a result, the quality of the overlay display on one or more display devices may be based on the corresponding device overlay color values. Such an approach may thus, provide an enhanced user experience.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method comprising:
receiving a plurality of configured values,
generating a plurality of effective values based on the plurality of configured values and a plurality of settings values,
configuring an overlay hardware based on a plurality of effective values, and
displaying one or more overlays based on the plurality of effective values on one or more display devices.

2. The method of claim 1 comprises computing a plurality of graphics hardware correlated values based on the plurality of settings values.

3. The method of claim 1 comprises receiving a brightness configured value, a gamma configured value, a contrast configured value, a saturation configured value, and a hue configured value from a user.

4. The method of claim 2 comprises computing a brightness graphics hardware correlated value, a gamma graphics hardware correlated value, a contrast graphics hardware correlated value, a saturation graphics hardware correlated value, and a hue graphics hardware correlated value by correlating the plurality of settings values into a corresponding range of graphics hardware values.

5. The method of claim 2 computing the plurality of effective values further comprises determining a brightness effective value by computing a sum of a brightness configured value and the brightness graphics hardware correlated value, a gamma effective value by computing a product of a gamma configured value and a gamma graphics hardware correlated value, a contrast effective value by computing a product of a contrast configured value and a contrast graphics hardware correlated value, a saturation effective value by computing a product of a saturation configured value and a saturation graphics hardware correlated value, and a hue effective value by computing a product of a hue configured value and a hue graphics hardware correlated value.

6. The method of claim 1 receiving the plurality of settings values provided by a graphics application.

7. An apparatus comprising:
a graphics interface to receive a plurality of configured values,
a display controller to generate a plurality of effective values based on the plurality of configured values and a plurality of settings values,
the display controller to configure an overlay hardware based on a plurality of effective values, and
the display controller to display one or more overlays based on the plurality of effective values on one or more display devices.

8. The apparatus of claim 7 the display controller to compute a plurality of graphics hardware correlated values based on the plurality of settings values.

9. The apparatus of claim 7 the display controller to receive a brightness configured value, a gamma configured value, a contrast configured value, a saturation configured value, and a hue configured value from a user.

10. The apparatus of claim 8 the display controller to compute a brightness graphics hardware correlated value, a gamma graphics hardware correlated value, a contrast graphics hardware correlated value, a saturation graphics hardware correlated value, and a hue graphics hardware correlated value by correlating the plurality of settings values into a corresponding range of graphics hardware values.

11. The apparatus of claim 8 the display controller to determine a brightness effective value by computing a sum of a brightness configured value and the brightness graphics hardware correlated value, a gamma effective value by computing a product of a gamma configured value and a gamma graphics hardware correlated value, a contrast effective value by computing a product of a contrast configured value and a contrast graphics hardware correlated value, a saturation effective value by computing a product of a saturation configured value and a saturation graphics hardware correlated value, and a hue effective value by computing a product of a hue configured value and a hue graphics hardware correlated value.

12. The apparatus of claim 7 the display controller to receive the plurality of settings values from a graphics application.

13. A machine readable medium comprising a plurality of instructions that in response to being executed result in a computing device
receiving a plurality of configured values,
generating a plurality of effective values based on the plurality of configured values and a plurality of settings values,
configuring an overlay hardware based on a plurality of effective values, and
displaying one or more overlays based on the plurality of effective values on one or more display devices.

14. The machine readable medium of claim 13 comprises computing a plurality of graphics hardware correlated values based on the plurality of settings values.

15. The machine readable medium of claim 13 comprises receiving a brightness configured value, a gamma configured value, a contrast configured value, a saturation configured value, and a hue configured value from a user.

16. The machine readable medium of claim 14 comprises computing a brightness graphics hardware correlated value, a gamma graphics hardware correlated value, a contrast graphics hardware correlated value, a saturation graphics hardware correlated value, and a hue graphics hardware correlated value by correlating the plurality of settings values into a corresponding range of graphics hardware values.

17. The machine readable medium of claim 14 comprises computing the plurality of effective values further comprises determining a brightness effective value by computing a sum of a brightness configured value and the brightness graphics hardware correlated value, a gamma effective value by computing a product of a gamma configured value and a gamma graphics hardware correlated value, a contrast effective value by computing a product of a contrast configured value and a contrast graphics hardware correlated value, a saturation effective value by computing a product of a saturation configured value and a saturation graphics hardware correlated value, and a hue effective value by computing a product of a hue configured value and a hue graphics hardware correlated value.

18. The machine readable medium of claim 13 receiving the plurality of settings values provided by a graphics application.

19. A system comprising:
a processor coupled to a graphics controller,
a memory coupled to the graphics controller,
a plurality of input-output devices including a plurality of display devices coupled to the graphics controller, and
the graphics controller to receive a plurality of configured values, to generate a plurality of effective values based on the plurality of configured values and a plurality of settings values, to configure an overlay hardware based on a plurality of effective values, and to display one or more overlays based on the plurality of effective values on a display device.

20. The system of claim 19 comprises the graphics controller to compute a plurality of graphics hardware correlated values based on the plurality of settings values by correlating the plurality of settings values into a corresponding range of graphics hardware values.

21. The system of claim 19 comprises the graphics controller to generate a graphical user interface to enable a user to provide the plurality of configured values, wherein the plurality of configured values comprise values of a gamma, brightness, contrast, saturation, and hue.
